(19) United States
(12) Patent Application Publication
(10) Pub. No.: US 2008/0073260 A1
(43) Pub. Date: Mar. 27, 2008

(54) Device For Reducing Microorganisms With Ultrasonic Waves

(75) Inventor: Kokichi Ido, Chiba-shi (JP)

Correspondence Address: RANKIN, HILL & CLARK LLP, 925 EUCLID AVENUE, SUITE 700, CLEVELAND, OH, 44115-1405, US

(73) Assignee: ELEKON SCIENCE CO., LTD., Chiba-shi (JP)

(21) Appl. No.: 11/859,845

(22) Filed: Sep. 24, 2007

(30) Foreign Application Priority Data
Sep. 26, 2006 (JP) 2006-260439

(51) Int. Cl. B01D 29/56; B01J 19/08; B06B 1/20

(52) U.S. Cl. 210/202; 210/323.2; 422/128; 422/186.3

(57) ABSTRACT

A device for reducing microorganisms comprising:
an outer cylinder which liquid to be processed flows into;
a mesh inner cylinder which is disposed inside the outer cylinder; and
an ultrasonic oscillator which is disposed inside the mesh inner cylinder.

### RELATED APPLICATIONS

This application claims priority to the Japanese Patent Application 2006-260439 dated on Sep. 26, 2006 and is hereby incorporated with reference for all purposes.

### BACKGROUND OF THE INVENTION

1. Field of the Invention

This invention relates to a device for reducing microorganisms with ultrasonic waves, and more particularly, to an improved mechanism for reducing microorganisms in a liquid medium.

2. Prior Art

Among the sterilizers or devices for reducing microorganisms, such as a water-purifying device, whose processing object or medium is liquid, devices making use of photocatalytic action, ultrasonic waves, or filters or the combination thereof have been known. For example, a sterilizer making use of photocatalytic action is disclosed in Japanese Unexamined Patent Application Publication No. 2004-148285 and a device for reducing microorganisms making use of ultrasonic waves is disclosed in Japanese Unexamined Patent Application Publication No. 2000-177718.

However, when using the sterilizer making use of photocatalytic action (especially ultraviolet waves) or the device for reducing microorganisms making use of ultrasonic waves, it is not possible to irradiate the entire liquid that is to be processed because a “shade”, an unirradiated part, occurs in the liquid.

Especially if the liquid to be processed includes suspended solids, it has been difficult to sterilize the liquid completely when microorganisms adhere to the unirradiated part (“shadow”) caused by the suspended solids.

On the other hand, a device for reducing microorganisms which includes a filter has a cost disadvantage for the filter for removing microorganisms can easily become clogged owing to the extremely small pore diameter of the filter, thereby requiring continuous replacement.

### SUMMARY OF THE INVENTION

The present invention has been conceived in light of the above-described problems in the related art. An object of the present invention is to provide a device for reducing microorganisms with ultrasonic waves which has an efficient process to reduce microorganisms and furthermore a low maintenance cost.

In order to achieve the object described above, the device for reducing microorganisms according to the present invention comprises an outer cylinder which liquid to be processed flows into, a mesh inner cylinder which is disposed inside the outer cylinder, and an ultrasonic oscillator which is disposed inside the mesh inner cylinder.

According to the present invention, moreover, it is preferred that the mesh inner cylinder comprises a mesh cylindrical body and a bottom filter which is disposed at an end of the mesh cylindrical body. It is also preferred that the pore diameter of the mesh cylindrical body is smaller than the pore diameter of the bottom filter, and that the mesh inner cylinder discharges the processed liquid after passing through the cylinder to the bottom filter.

The invention further provides a multi-connected device for reducing microorganisms with ultrasonic waves that comprises at least two devices described above that are connected together and a UV lamp in place of an ultrasonic oscillator is disposed inside the inner cylinder of at least one of these devices.

According to the device for reducing microorganisms of the present invention, the process for reducing microorganisms is more efficient because the filtered liquid from which large suspended solids has been removed by a mesh inner cylinder is irradiated with ultrasonic waves. Moreover, the frequency of maintaining the device is largely decreased because ultrasonic waves help to prevent the adhesion of suspended particles within the inner cylinder of the device.

### BRIEF DESCRIPTION OF THE DRAWINGS

FIG. 1 is a sectional view of a device for reducing microorganisms according to an embodiment of the present invention.

FIG. 2 is a schematic diagram illustrating the operation of the device shown in FIG. 1.

FIG. 3 is a schematic diagram of a multi-connected device for reducing microorganisms according to an embodiment of the present invention.

FIG. 4 is a schematic diagram showing the placement of an inner cylinder and an ultrasonic oscillator in a device for reducing microorganisms according to an embodiment of the present invention.

### DESCRIPTION OF THE PREFERRED EMBODIMENT

Preferred embodiments of the present invention will be described below based on the drawings.

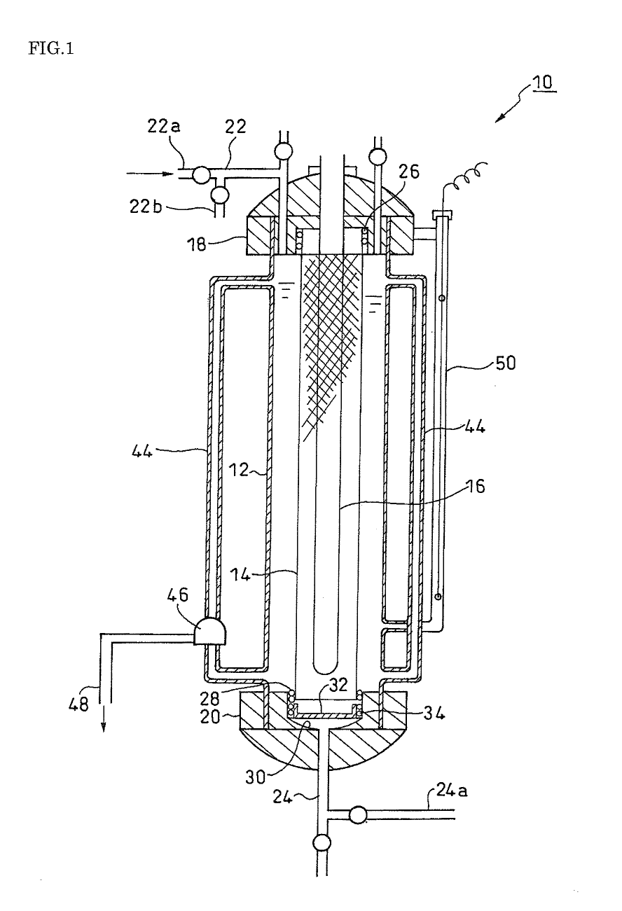

FIG. 1 shows a sectional view of a device for reducing microorganisms 10 according to an embodiment of the present invention. In this view, the device for reducing microorganisms 10 includes an outer cylinder 12 which liquid to be processed flows into, a mesh inner cylinder 14 which is disposed inside the outer cylinder 12, and an ultrasonic oscillator 16 which is disposed inside the mesh inner cylinder 14.

The outer cylinder 12 is made of resin or corrosion resistant metal. An upper cap 18 is fit in watertightly at the top of the outer cylinder 12 and a lower cap 20 is fit in watertightly at the bottom of the outer cylinder 12. The upper cap 18 is provided with an inlet tube for liquid to be processed 22 and the lower cap 20 is provided with an outlet tube for processed liquid 24.

The mesh inner cylinder 14 is made of hard material which resists attenuating ultrasonic waves, and it preferably comprises a corrosion resistant metal. The top of the inner cylinder 14 is secured to the upper cap 18 by a first circumferential seal 26 so that liquid to be processed does not flow into the inner cylinder by taking a shorter route. The bottom of the inner cylinder 14 is secured to the lower cap 20 by a second circumferential seal 28. The lower cap 20 has a fitting hole 30 for the inner cylinder 14 at the center of the upper part, and an outlet tube for processed liquid 24 is connected to the bottom of the fitting hole 30. A bottom filter (bottom filter part) 32 is fitted in the lower part of the fitting hole 30 by a third circumferential seal 34, and the inner cylinder 14 is fitted in the upper part of the fitting hole 30 by a second circumferential seal 28.

In the illustration of the drawings, a pore diameter of an inner cylinder is set to be 500 to 50 μm and a pore diameter of a bottom filter is set to be 300 to 0.2 μm. It is preferred herein that a pore diameter of a bottom filter is no more than a half of a pore diameter of an inner cylinder.

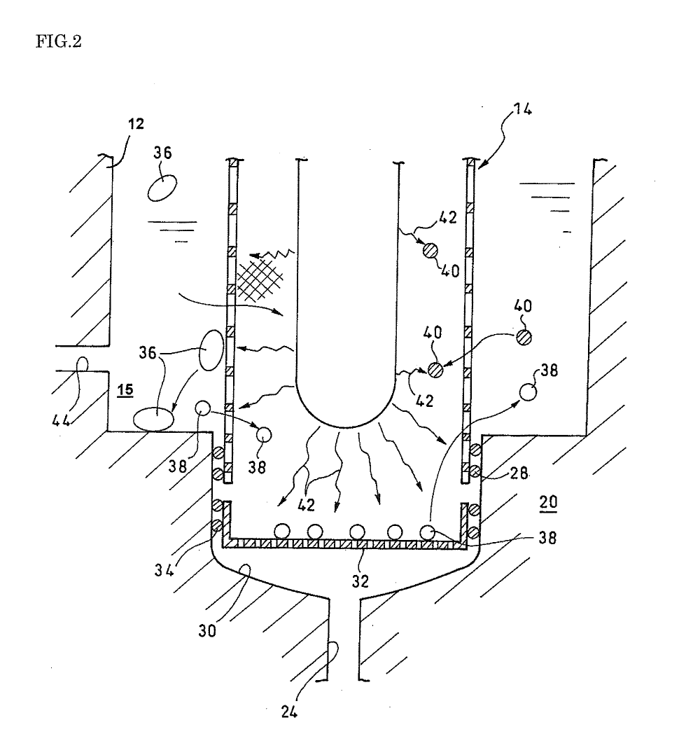

A device for reducing microorganisms according to an embodiment of the present invention largely comprises as mentioned above, and the mechanism will be described below with reference to FIG. 1 and FIG. 2.

FIG. 2 is a view to describe a mechanism of a device for reducing microorganisms 10 of this invention. As illustrated in FIG. 2, liquid to be processed which flows into the device for reducing microorganisms 10 stays inside the outer cylinder 12. Then large suspended solids 36 in the liquid to be processed are filtered by the mesh inner cylinder 14 and they are retained in the filter area 15 between the outer cylinder 12 and the inner cylinder 14 without flowing into the inside of the inner cylinder 14. On the other hand, liquid phase, small suspended solids 38, and microbes 40 pass through the mesh inner cylinder 14 and the microbes 40 are sterilized to cause membrane breakdown by close-in irradiation of ultrasonic waves 42 produced by the ultrasonic oscillator 16.

Because the large suspended solids 36 do not flow into the inner cylinder 14 as described above, the microbes, such as the microbes which adhere to the large suspended solids 36, which are difficult to sterilize by ultrasonic waves when they adhere to the unirradiated parts (shadows) of the suspended solids, hardly exist inside the inner cylinder 14. Thus, the process to reduce microorganisms of the present invention is extremely efficient.

The processed liquid is further filtered with a bottom filter 32 disposed at the lower part of the inner cylinder 14, and the liquid then is discharged from the outlet tube for processed liquid 24 while small suspended solids 38 are filtered out by the filter 32.

At this time, because irradiation of ultrasonic waves to the inner cylinder 14 and the bottom filter 32 prevents a hard adhesion of suspended solids 36 and suspended solids 38, the large suspended solids 36 on the outer surface of the inner cylinder 14 are removed one after another and they settle near the bottom of the outer cylinder 12 in the filter area 15, and the small suspended solids 38, sterilized microbes 40 and so on inside the inner cylinder 14 are agitated with ultrasonic waves and then a part of them is discharged out of the inner cylinder 14.

As described above, in a device for reducing microorganisms 10 according to an embodiment of this invention, suspended solids 36 and suspended solids 38 are filtered while microbes 40 are sterilized efficiently. In addition, the mesh inner cylinder 14 or the bottom filter 32 is not clogged with the suspended solids 36 or suspended solids 38.

A device for reducing microorganisms 10 includes a circulation pipe 44, of which a circulation pump 46 is disposed in the middle thereof. Suspended solids 36 or 38, or microbes 40 which precipitate at the bottom of the outer cylinder 12 in filter area 15 during a steady operation are circulated into the upper part of the outer cylinder 12 by means an action of circulation pump 46 and this circulation prevents suspended solids 36 or 38, or microbes 40 from accumulating excessively at the bottom of the outer cylinder 12 and obstructing the filtration process. When a certain amount of suspended solids 36 or 38, or microbes 40 accumulate at the bottom of the outer cylinder 12, these accumulations are discharged to the outside through a drainpipe 48 by means of the action of the pump 46.

A device for reducing microorganisms 10 also includes a water gauge 50, which controls liquid to be processed that flows from the inlet tube 22.

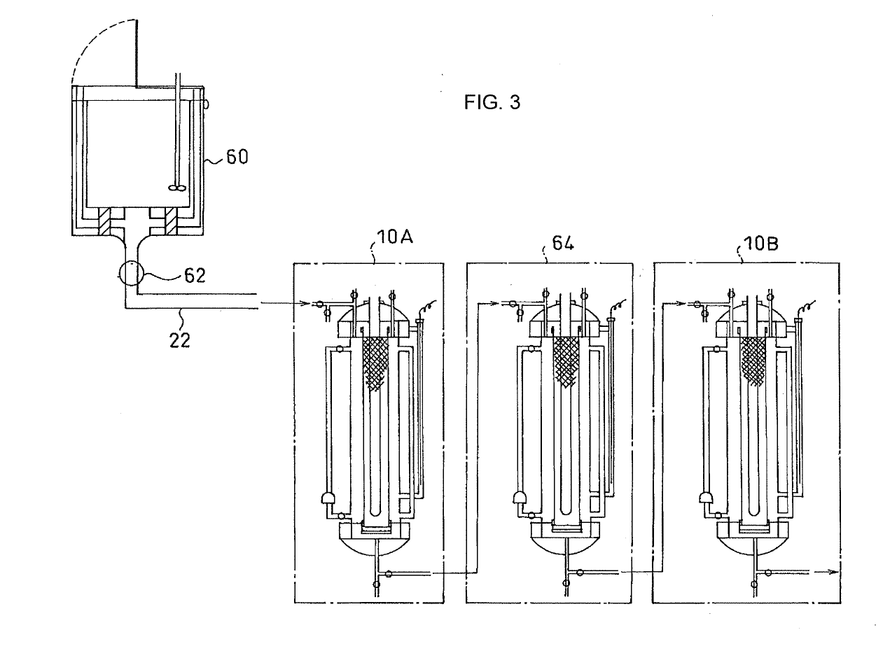

FIG. 3 shows a configuration according to the invention comprising multi-connected devices for reducing microorganisms when the liquid that is being processed has an extremely high concentration of solids and/or microbes. In FIG. 3, the liquid to be processed, such as barn animal waste, is stored in a storage tank 60 and the liquid is continuously pumped into the device for reducing microorganisms 10A part by part by means of the action of a supply pump 62.

In the embodiment of the present invention shown in FIG. 3, a device for reducing microorganisms 10A, a device for reducing microorganisms 10B, and a device for reducing microorganisms with ultraviolet waves 64 is illustrated. The device for reducing microorganisms 10A and the device for reducing microorganisms 10B have the configuration showed in FIG. 1, and the pore diameter of the mesh inner cylinder in the device for reducing microorganisms 10B is set to be smaller than the pore diameter of the bottom filter in the device for reducing microorganisms 10A. While the device for reducing microorganisms with ultraviolet waves 64 has basically the same configuration as the device for reducing microorganisms 10 shown in FIG. 1, a UV lamp instead of an ultrasonic oscillator is located in its inner cylinder and the pore diameter of its inner cylinder and bottom filter are as large as or larger than a pore diameter of a bottom filter in the upstream device for reducing microorganisms 10A.

For an example, the pore diameter of the mesh inner cylinder of the device for reducing microorganisms 10A is specifically set to be 100 μm, the pore diameter of the bottom filter in the device for reducing microorganisms 10A is specifically set to be 50 μm, the pore diameter of the mesh inner cylinder in the device for reducing microorganisms 10B is specifically set to be 30 μm, the pore diameter of the bottom filter in the device for reducing microorganisms 10B is specifically set to be 10 μm, and the pore diameter of both the mesh inner cylinder and the bottom filter of the device for reducing microorganisms with ultraviolet waves 64 is specifically set to be 50 μm.

As a result, an preliminary process to reduce microorganisms is performed in the device for reducing microorganisms 10A and the device for reducing microorganisms 10B by the mechanism shown in FIG. 1 and FIG. 2, and clogging of the inner cylinders and the bottom filters is prevented. Because the inner cylinder and the bottom filter are not irradiated with ultrasonic waves in the device for reducing microorganisms with ultraviolet waves 64, the prevention of clogging is accomplished by setting pore diameters of the inner cylinder and the bottom filter in the device 64 to be as large as or larger than the pore diameter of the bottom filter in the upstream device for reducing microorganisms 10A so that basically all suspended solids pass through and the liquid is only sterilized with ultraviolet waves.

A further advanced removal and reduction of suspended solids is performed by setting pore diameters of the inner cylinder and the bottom filter in the device for reducing microorganisms 10B to be smaller than the pore diameters of the inner cylinder and the bottom filter in the device for reducing microorganisms 10A.

In this way, in this embodiment, placing devices for reducing microorganisms to be multi-connected makes it possible to perform more advanced process which is different from the process for reducing microorganisms with ultrasonic waves or ultraviolet waves and furthermore it is possible to filter more microscopic suspended solids.

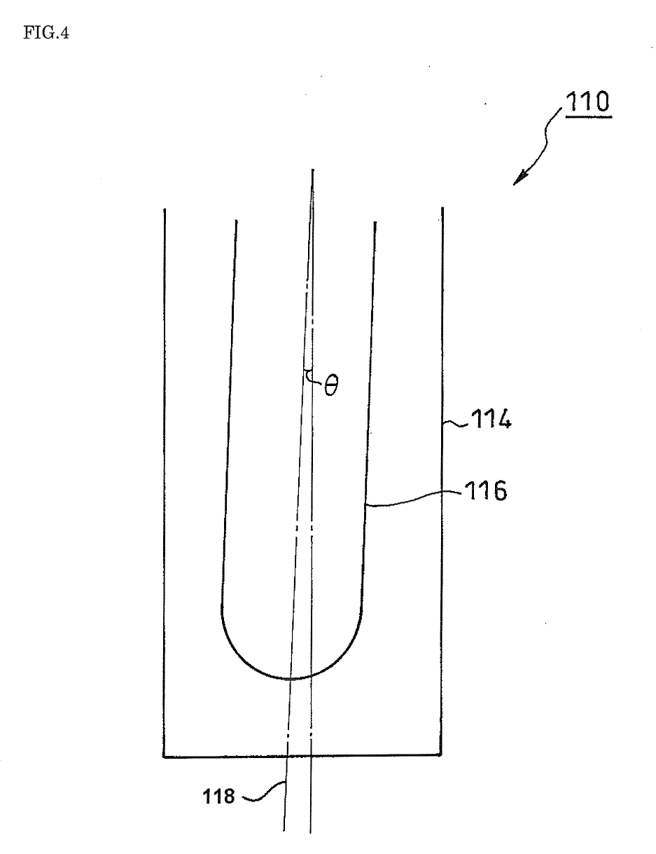

FIG. 4 shows another embodiment of the device for reducing microorganisms according to this invention. The reference characters for the parts which correspond to the parts in FIG. 1 are indicated by adding 100 to the corresponding reference characters in FIG. 1 and their descriptions are omitted.

A device for reducing microorganisms 110 indicated in FIG. 4 includes an inner cylinder 114 and an ultrasonic oscillator 116. The ultrasonic oscillator 116 is disposed having an inclination relatively to the inner cylinder 114 with a θ degree angle. As a result of the detailed experiments, it was observed that a process to reduce microorganisms becomes more efficient by placing an ultrasonic oscillator on such a slant. It is preferred herein that the angle of inclination θ is from 2 to 10 degrees from the vertical axis 118 of the device 110.

In accordance with this invention, in a device for reducing microorganisms with an ultrasonic oscillator, the process to reduce microorganisms becomes further efficient by using an inner cylinder made of silver.

In a device for reducing microorganisms with a UV lamp, a process to reduce microorganisms also becomes further efficient by using an inner cylinder which is made of titanium or is provided with a titanium oxide coating having photocatalytic action.

With the present invention processing capability is enhanced by placing multiple elements of the device in parallel or in series when the amount of liquid required to be processed is large. For example, it is possible that a number of mesh inner cylinders may be disposed inside a large-diameter outer cylinder, and ultrasonic oscillators or UV lamps may be inserted in each mesh inner cylinder.

In the embodiment indicated in FIG. 1, it is preferred that a inlet tube 22, which is bifurcated, includes an inlet tube for liquid to be processed 22a and an inlet tube for dilution water 22b, and thus liquid to be processed which flows into a device for reducing microorganisms may be diluted so that the amount of solids or microbes in it can be altered or held constant depending upon how much dilution water is utilized.

In the embodiment indicated in FIG. 1, it is preferred that the outlet tube 24, which is bifurcated, includes an outlet tube 24a and a backwash tube 24b, and the bottom filter 32 or the inner cylinder 14 may be washed with backwash water brought from the backwash tube 24b at regular time intervals.

In another preferred embodiment according the invention a part of the processed water is brought out from the outlet tube 24 and is always or intermittently returned to the inner portion 15 of the cylinder 14 in the filtering area of bottom filter 32 so that such water can be reprocessed by bottom filter 32.

What is claimed is:

1. A device for reducing microorganisms comprising:
an outer cylinder which liquid to be processed flows into;
a mesh inner cylinder which is disposed inside the outer cylinder; and
an ultrasonic oscillator which is disposed inside the mesh inner cylinder.

2. A device for reducing microorganisms according to claim 1, wherein the mesh inner cylinder comprises:
a mesh cylindrical body; and
a bottom filter which is disposed at an end of the mesh cylindrical body,
wherein a pore diameter of the mesh cylindrical body is smaller than a pore diameter of the bottom filter, and
discharges processed liquid which passed through the bottom filter.

3. A multi-connected device for reducing microorganisms wherein at least more than two devices according to claim 1 are interconnected and a UV lamp instead of an ultrasonic oscillator is disposed inside the inner cylinder of at least one of the devices.

4. A multi-connected device for reducing microorganisms wherein at least more than two of the devices according to claim 2 are interconnected and a UV lamp instead of an ultrasonic oscillator is disposed inside the inner cylinder of at least one of these devices.

5. A device for processing a liquid medium containing particulates comprising:
an inlet into which the liquid medium is introduced into the device,
an outlet from which the liquid medium subsequent to filtering and treatment exits the device,
an inner cylinder comprising a porous mesh that serves to remove some of the particulates from the liquid medium,
an outer cylinder that partially encircles the inner cylinder that is spaced from said inner cylinder to permit the inflow of such liquid medium into said device and into the inner cylinder and permit the accumulation of some of the particulates in a space located between the inner cylinder and the outer cylinder,
a bottom filter comprising a porous mesh located immediately adjacent to the distal end of the inner cylinder and in the proximity of the drain of the device, the liquid medium flowing from the inner cylinder and then into the bottom filter prior to the liquid medium exiting the device, and
a drain for removing at least a portion of the particulates that accumulate in the space between the inner cylinder and the outer cylinder.

6. The device of claim 5 wherein said drain comprises a pump for circulating said particulates and preventing their excessive accumulation in the space between the inner cylinder and the outer cylinder.

7. The device of claim 6 wherein said pump also serves to siphon off and remove said particulates.

8. The device of claim 5 further including a UV lamp disposed within the inner cylinder for treating the liquid medium that flows into the inner cylinder.

9. The device of claim 5 further including an ultrasonic generator disposed within the inner cylinder for treating the liquid medium that flows into the inner cylinder.
